(19) United States
(12) Patent Application Publication
(10) Pub. No.: US 2017/0058185 A1
(43) Pub. Date: Mar. 2, 2017

(54) INHIBITION OF ASPHALTENE

(71) Applicant: New York University, New York, NY (US)

(72) Inventors: Pance Naumov, Abu Dhabi (AE); Jamie Whelan, Abu Dhabi (AE)

(21) Appl. No.: 15/348,462

(22) Filed: Nov. 10, 2016

Related U.S. Application Data
(63) Continuation-in-part of application No. PCT/US15/30205, filed on May 11, 2015.
Application No. PCT/US15/30205 is a continuation-in-part of application No. PCT/US15/30208, filed on May 11, 2015.
(60) Provisional application No. 61/992,078, filed on May 12, 2014.
(60) Provisional application No. 61/992,072, filed on May 12, 2014.

(51) Int. Cl. C09K 8/524; F17D 1/16; E21B 37/06

(52) U.S. Cl. CPC C09K 8/524; E21B 37/06; F17D 1/16

(57) ABSTRACT

Methods, systems and compositions reduce or prevent the formation of asphaltene deposits by controlling the precipitation of asphaltene. An asphaltene inhibitor is utilized comprising an aromatic core. The asphaltene inhibitor is introduced into a well or pipeline. The method of utilizing the inhibitor may include the use of a downhole continuous injection process or squeeze treatment. A method of reducing asphaltene scale deposition including adding an asphaltene scale deposition squeeze treatment inhibitor to a hydrocarbon reservoir is provided. The asphaltene scale deposition squeeze treatment inhibitor may be added to the hydrocarbon reservoir by a squeeze treatment process.

### CROSS-REFERENCE TO RELATED APPLICATIONS

This application claims the benefit of PCT Application PCT/US2015/030208, which claims the benefit of Provisional Application No. 61/992,072 filed on May 12, 2014, which is hereby incorporated by reference in its entirety. This application also claims the benefit of PCT Application PCT/US2015/030205, which claims the benefit of U.S. Provisional Application No. 61/992,078 filed on May 12, 2014, which is hereby incorporated by reference in its entirety.

### BACKGROUND

Ensuring uninterrupted flow of hydrocarbons from reservoirs is important to the economies of many countries around the world. Scale deposition, both inorganic and organic, is detrimental to this flow assurance. Inorganic scale is a problem in wells with water cut. Organic scale, particularly asphaltenes, may occur in any well and at any stage in the process. Scale may form in the reservoir itself, at the surface facilities of the well, or at any point in between.

Asphaltenes are a chemical class of the heavy fraction of crude oil where they exist as a mixture with asphaltenogenic acids, diamondoid compounds, mercaptans, organometallics, paraffins/waxes and resins. Being the most polar component of crude, they may be solubilized by aromatics and resins or through polar interactions with their own partial charges or polar resins. While asphaltenes are always present in hydrocarbon reservoirs, they may become problematic once they are destabilized in solution, leading to asphaltene scale deposition. In crude oil, asphaltenes may be stabilized and held in solution by interactions between their partial charges and surfactant polar groups of natural resins. The asphaltenes may be destabilized from solution in any part of the oil production pipeline, from the wellbore area to the refinery. The destabilization of the asphaltenes from the solution may occur through changes in temperature, pressure and/or chemical composition. Asphaltenes may attach readily to surfaces, due to the pronounced stickiness of the asphaltenes, and change the wettability properties thereof. Asphaltenes may also cause the nucleation of crystals of other compounds, notably paraffins/waxes and diamondoid compounds.

The formation of asphaltene deposits in the oil production pipeline may cause operational problems, such as the partial or total blockage of pipelines. The formation of asphaltene deposits may also produce health, safety and environment (HSE) concerns by disrupting sub-surface safety valve operation. Deposition may induce formation of suspended particles which may cause fouling, foaming, erosion and/or corrosion.

Asphaltenes may also be destabilized in solution by changes in some or all of the following parameters of the solution: temperature, pressure and/or chemical composition. Changes in the temperature and pressure of the solution may occur during normal production. The chemical composition of the solution may be changed as a result of strategies employed for enhanced oil recovery (EOR), such as hydrocarbon or CO₂ gas injection. As CO₂ gas injection for EOR increases, the potential for greater asphaltene scale deposition may also increase.

Mitigation of asphaltene scale deposition typically involves periodic clean-up operations. The clean-up operations may include washing away the asphaltene scale deposits with a solvent that contains low concentrations of dispersants. However, this method of mitigation is time, labor, and cost intensive. For example, wells that produce severe asphaltene scale deposition may require 3 or 4 clean-up operations per year, with each clean-up operation having a cost of about $200,000.

### SUMMARY

An asphaltene precipitation and/or flocculation inhibitor with a molecular weight of less than about 1000, wherein the asphaltene precipitation inhibitor comprises an aromatic core, is provided. The inhibitor may have a molecular weight of at least about 78.

A method of reducing asphaltene precipitation and/or flocculation including adding an asphaltene precipitation inhibitor with a molecular weight of less than about 1000 to a hydrocarbon reservoir, well or oil production pipeline, is provided. The addition of the asphaltene precipitation inhibitor may include a downhole continuous injection process or a squeeze treatment process.

An asphaltene scale deposition squeeze treatment inhibitors exhibiting a lifetime of at least about 6 months is provided.

A method of reducing asphaltene scale deposition including adding an asphaltene scale deposition squeeze treatment inhibitor to a hydrocarbon reservoir is provided. The asphaltene scale deposition squeeze treatment inhibitor may be added to the hydrocarbon reservoir by a squeeze treatment process.

It is to be understood that both the foregoing general description and the following detailed descriptions are exemplary and explanatory only, and not restrictive of the inventions.

### BRIEF DESCRIPTION OF THE DRAWINGS

These and other features, aspects and advantages of the present invention will become apparent from the following description and the accompanying exemplary embodiments shown in the drawings, which are briefly described below.

FIG. 1 is a variety of exemplary asphaltene chemical structures.

FIG. 2 is a schematic representation of asphaltenes, polyaromatic charge-transfer inhibitors, the mechanism of precipitation of asphaltenes, and the mechanism of inhibition of asphaltene precipitation and/or flocculation.

FIG. 3 depicts a variety of chemical stabilizers that stabilize asphaltene precipitation.

### DETAILED DESCRIPTION

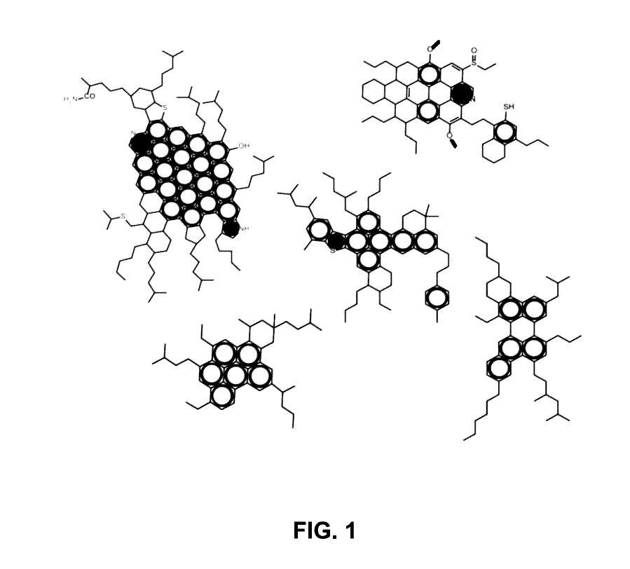

In one embodiment, the formation of asphaltene deposits (such as those shown in FIG. 1) may be reduced or prevented by controlling the precipitation of asphaltene. In practice, the deposition of asphaltene may be controlled by techniques that are classified in six categories: alterations of the production scheme, chemical treatment, external force field techniques, mechanical treatment, thermal treatment, and biological treatment.

The chemical treatment techniques may include the addition of dispersants, antifoulants, coagulants, flocculants and polar co-solvents to control the deposition at various stages of the oil production pipeline. The chemical treatment techniques may be employed as preventive or remedial measures. The chemical treatment techniques may include downhole continuous injection (DCI) or squeeze treatment. DCI may include providing an inhibitor as a chemical treatment to a well and thereby a rock formation of a hydrocarbon reservoir prior to asphaltene deposition. A squeeze treatment may include supplying an inhibitor as a chemical treatment to a hydrogen reservoir such that the inhibitor is adsorbed on to the formation minerals of the hydrocarbon reservoir by a physicochemical process through electrostatic and van der Waals interactions and the released slowly over time.

The dispersants may surround asphaltene molecules to form steric colloids similar to the natural resins, and maintain the asphaltene in solution. The antifoulants may be introduced as a coating on the surfaces and/or walls of hydrocarbon reservoirs or pipelines to prevent the adhesion of asphaltene deposits, and may include polytetrafluoroethylene (PTFE) or organotin compounds. The coagulants, such as polymers, may act similarly to resins in forming colloids and flocs, causing flocculation and precipitation of asphaltenes. The polar co-solvents, such as aromatic hydrocarbons, may act by the re-dissolution of already formed asphaltene deposits. The aromatic hydrocarbons may be benzene, toluene, xylenes, or chlorinated aromatics. In the presence of excess aromatic hydrocarbons, micelles may be formed which can be removed by using steam, a diesel oil wash, a heavy aromatic wash, or a mixture of additives to stimulate the wells. However, even the best performing aromatic solvents may be flammable, carcinogenic, dangerous to handle, and harmful to the environment.

Chemical stabilizers or inhibitors may act similarly to resins by peptizing asphaltenes and retaining the asphaltenes in solution. A comparative study of a number of surfactants, resins and aromatic solvents indicated that surfactants such as nonyl phenol, dodecylbenzenesulfonic acid and dodecylresorcinol are more effective in inhibiting asphaltene precipitation than resins, due to the interaction between the acidic sites of these molecules with asphaltene. The surfactants may include a polar head that interacts with asphaltene micelles, producing a stabilizing effect and thereby inhibiting asphaltene precipitation.

The resins obtained from a crude oil have a modest asphaltene precipitation inhibition capability. For example, deasphalted oil is a poor inhibitor with significant inhibition activity only at mass fractions above 60%. Oil-soluble amphiphiles of natural origin may perform fairly well as asphaltene precipitation inhibitors, while organic acids, such as linolenic, caprylic, and palmytic acids, are comparably less effective asphaltene precipitation inhibitors. The amphiphiles of natural origin may be vegetable oils, such as coconut, almond, andiroba and sandalwood oils. An alternative approach is to utilize refinery stream by-products, such as light cycle oil (LCO), heavy cycle oil (HCO) and diesel, as asphaltene precipitation inhibitors. These refinery stream by-product additives are limited in effectiveness due to the high dose required, such as about 30-50%, as compared to the required dose of commercial asphaltene precipitation inhibitors of about 0.8-1%. Some esters of polyhydroxyl alcohols with carboxylic acids and ethers are very effective asphaltene precipitation inhibitors, but tend to hydrolyze rapidly even at ambient pressure and temperature and rapidly lose effectiveness.

Although in most cases chemical treatment techniques provide a cost-effective alternative to mechanical methods for prevention of the deposition of asphaltenes in wells and flow lines, the efficacy of the chemical treatments depends greatly on the composition of the oil which may vary from one oil well to the next. The performance may also vary with time due to compositional changes and variation in the ambient conditions, such as pressure and temperature, as well as on the dispersion medium. Whether basic or acidic asphaltene precipitation inhibitors will be more effective may depend on the characteristics of the crude oil.

Due to a lack of chemical functionalities, asphaltenes are a chemically inert species. Asphaltenes include an aromatic core and side chains. The aromatic core may be a stable polycyclic system, and the side chains may be non-reactive alkyl groups. If asphaltenes include hetero-centers, the hetero-centers may be limited to one or a plurality of hetero atoms, such as sulfur, nitrogen, and oxygen, whose number may vary across the asphaltene fraction. The conjugated condensed aromatic core of an asphaltene may be the most important aspect of asphaltene chemistry from the viewpoint of interaction with potential inhibitors, and offers a common yet previously unexploited potential for interaction with other molecules. Spectroscopic analysis has indicated that asphaltenes interact with small aromatic charge-transfer molecules, such as chloranil or nitrobenzene.

A new class of chemical inhibitors of asphaltene precipitation and/or deposition includes aromatic charge-transfer molecules of small molecular weight. The aromatic charge-transfer molecules of small molecular weight may be monoaromatic or polyaromatic. The aromatic charge-transfer molecules of small molecular weight are fundamentally different than pre-existing chemical inhibitors that were based on acid-base interactions with functional groups of asphaltenes.

The aromatic charge-transfer molecules may have a small relative molecular weight (Mᵣ), such as less than about 1000. The molecular weight of the aromatic charge-transfer molecules may be at least about 78. According to one embodiment, the molecular weight of the aromatic charge-transfer molecules may be in the range of about 78 up to about 1000.

The aromatic charge-transfer molecules are efficient precipitation and/or deposition inhibitors for the selective interaction and stabilization of asphaltenes in crude oil. The extensive π-π interactions between asphaltenes and the aromatic charge-transfer compounds form stable non-covalent molecular complexes to prevent the aggregation of asphaltenes with other asphaltene-like molecules. The π-π interactions are increased by the extended aromatic nature of asphaltenes and the inhibitor. The charge transfer properties of the inhibitor may be chemically modified by employing various donor and acceptor chemical functional groups, allowing selective inhibition and stabilization of asphaltenes in solution.

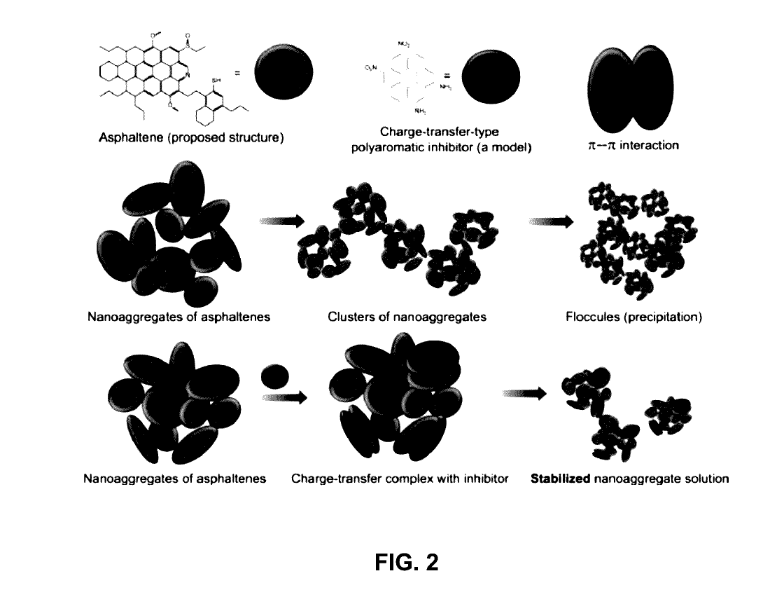

The electronic structure and properties of the charge-transfer additive may be tuned by chemical modifications, such as altering the chemical groups and geometry, to strongly and selectively interact with a desired class of asphaltenes by formation of charge-transfer molecular complexes, as shown in FIG. 2. In these complexes, one to three flat molecules of the inhibitor interact with asphaltene nanoaggregates composed of asphaltene molecules to form a tightly bound molecular complex. The nanoaggregates may include at least about a dozen asphaltene molecules. According to another embodiment, the nanoaggregates may include less than about a dozen asphaltene molecules. In the molecular complex, the inhibitor molecules are bound face-to-face by overlap of their π orbitals with asphaltene molecules of the nanoaggregate. Such complexes are very stable and prevent interactions between the asphaltene nanoaggregates, thereby effectively stabilizing the asphaltene micelles. The inhibitors may have various sizes and aromaticity, as well as with various capabilities for π-π interaction with asphaltenes. To avoid precipitation of the inhibitors and to stimulate solubility, the core structures of the inhibitors may be based on small polycyclic aromatic systems, such as condensed aromatic benzene rings. The electronic properties of these molecules and their selectivity may be tuned by introducing electronically active substituents of the push-pull type to the molecules, altering the electronic density on the molecular surface. By altering the molecular surface electronic density, the interaction with asphaltenes and the selectivity towards various core structures of asphaltenes of the inhibitors may be controlled.

The inhibitors may include an aromatic core and functional groups. The aromatic core may be any suitable aromatic core, such as a monoaromatic core or a polyaromatic core. For example, the aromatic core may be benzene, naphthalene, anthracene, phenanthrene, pyrene, tetracene, pentacene, benzopyrene, chrysene or coronene. The similarity of the structures of the inhibitor and the asphaltenes may contribute to the solubility of the asphaltenes. The functional groups may provide the charge-transfer properties of the inhibitor, and the charge-transfer properties of the inhibitor may be altered by modifying the functional groups. The functional groups may have electron withdrawing or electron donating properties. The location of the functional groups on the aromatic core may be selected to modify the electron properties of the aromatic core. The chemical structure of the inhibitors may be optimized for specific conditions, such as on the basis of the conditions of a well to which the inhibitor will be added.

The inhibitors may be synthesized based on a condensed aromatic polycyclic platform. The multiple condensed ring fractions may be obtained by chemical, thermal or electrosynthetic approaches, and chemically functionalized by introducing electronically withdrawing or donating functional groups. The synthetic procedures may be optimized in terms of cost and time.

The inhibitors may prevent asphaltene aggregation and precipitation at three levels: stabilization of individual asphaltene molecules by formation of small asphaltene-inhibitor charge-transfer complexes which exist in solution as free solvated species; stabilization of asphaltene nanoaggregates by inclusion of the inhibitor in the micelles' interior modifying the electronic properties; and adsorption of the inhibitor on the surface of the nanoaggregates altering the surface electronic properties and preventing flocculation.

In addition to the standard analytical methods for evaluation of inhibitors, the evolution and disintegration of charge-transfer complexes between the inhibitors and asphaltenes may be investigated by a specially adapted X-ray diffraction technique. For that purpose, a liquid mixture of asphaltene and inhibitor may be used in a capillary in tandem with an optical heating crystallization device (OHCD). The OHCD allows direct analysis of the process of formation of the adducts between asphaltenes and the inhibitor with atomic-scale resolution. The OHCD setup includes a spatially controlled heating device based on a CO₂ laser for repeated heating to induce melting of a sample frozen in a capillary at low temperature. The focus of the laser may be shifted along the capillary so that while one portion of the liquid is frozen other portions remain liquid. The repeated, computer-controlled local heating cycles produce repeated in situ nucleation and melting. Upon crystallization of the sample, an X-ray diffractometer may be utilized to determine the crystal structure of the product to be determined, even when the product is liquid at ambient temperature. This experimental approach provides unique experimental information and the direct evidence of the mechanism of inhibition, which is not available from other analytical methods. Other spectroscopic and physicochemical, such as microfluidic, analysis methods may also be employed.

The efficacy of the inhibitor may be determined by titration with a low molecular mass n-alkane, such as n-heptane, and observation under a microscope to determine the onset of precipitation, which may be referred to as a “spot test”. The method is based on the capacity of the additive to maintain the asphaltene stabilized in the oil phase. Additionally, the asphaltene onset point may be determined as a control with a Solid Detection System (SDS) by using a PVT cell and a laser which detects the onset of organic colloid precipitation concurrently with the fluid volumetric data, including pressure, volume and temperature. Alternatively, millifluidic and microfluidic techniques may be employed for screening the samples.

The stability of the colloidal asphaltene, defined as the degree of its resistance to flocculation or coagulation, may be quantitatively expressed utilizing the Colloidal Instability Index (CII). In the CII, the asphaltene solution is considered as a colloidal solution made up of pseudo-components such as saturates, aromatics, resins and asphaltenes. The CII may be determined by the standard saturates, aromatics, resins and asphaltenes (SARA) analysis. The CII is defined as the ratio of the sum of asphaltene and its flocculants (saturates) to the sum of asphaltene peptizers (resins and aromatics):

CII=(asphaltenes+saturates)/(aromatics+resins).

The asphaltene adsorption on surfaces such as mica or glass in the presence of the inhibitor may be studied by using atomic force microscopy (AFM), confocal microscopy and scanning electron microscopy (SEM).

The asphaltene precipitation inhibitors may be added to a well, hydrocarbon reservoir, or oil production pipeline by any suitable process. The asphaltene precipitation inhibitors may be added by a DCI or squeeze treatment process.

In another embodiment, Inhibition of asphaltene scale deposition is an alternative approach directed at reducing or preventing asphaltene scale deposition. Inhibition may include restricting the initial flocculation of asphaltene, thereby reducing or preventing asphaltene scale deposition. An inhibition approach may include employing asphaltene scale deposition inhibitors, such as by downhole continuous injection (DCI) or squeeze treatment.

DCI employs a capillary string inserted in a well. DCI may be conducted using a rig or riglessly utilizing chemical injection skids arranged for continuous injection. A capillary string can only be inserted so far down the well. The portions of the well that extend beyond the end of the capillary string are therefore unprotected. Horizontal wells may include large portions of the wellbore that extend beyond the end of the capillary string and that are thus unprotected by DCI. In addition, the DCI process requires monitoring the injection skids, such as on a daily basis, and regular maintenance of the injection skids to maintain efficient operation.

Squeeze treatment adds asphaltene scale inhibitors directly to the hydrocarbon reservoir. The inhibitors in a squeeze treatment process adsorb to the rock forming the hydrocarbon reservoir and then release from the rocks maintaining the desired inhibitor concentration over time. The rock forming the hydrocarbon reservoir may be a carbonate. This process may reduce or eliminate manpower involvement after the time of inhibitor addition to the hydrocarbon reservoir and does not require modifications of existing wells or allows simplified future well design by not requiring a capillary string. Thus, squeeze treatment asphaltene scale deposition processes may be less time, labor and cost intensive than other asphaltene scale mitigation and inhibition processes. Pre-existing squeeze treatment asphaltene scale inhibitors are not as long-lasting as commonly employed squeeze treatment inorganic scale inhibitors, and thus must be added to the hydrocarbon reservoir more frequently. The pre-existing market leading squeeze treatment asphaltene scale inhibitors exhibit a useful lifetime after addition in some oil fields of only about 2 months, while inorganic scale inhibitors exhibit useful lifetimes on the order of years. The increased addition frequency of squeeze treatment asphaltene scale inhibitors undesirably increases the cost of asphaltene scale deposition squeeze treatment as a result of increased well interventions, well shut-ins and higher chemical volumes.

According to one embodiment, longer lasting asphaltene scale deposition squeeze treatment inhibitors are provided. The asphaltene scale deposition squeeze treatment inhibitors may exhibit a lifetime of at least about 6 months, such as at least about 7 months, about 8 months, about 9 months, about 10 months, about 11 months, about 12 months, or more. The squeeze treatment asphaltene scale inhibitors may exhibit a lifetime of at least about 300% greater than pre-existing squeeze treatment asphaltene scale inhibitors, such as at least about 400% greater, about 500% greater, or about 600% greater. The longer lasting asphaltene scale deposition squeeze treatment inhibitors may reduce operational costs and well downtime in comparison to pre-existing asphaltene scale deposition squeeze treatment inhibitors.

As utilized herein, lifetime may refer to the time which the squeeze treatment asphaltene scale inhibitors remain effective in preventing or reducing asphaltene scale deposition after addition to the hydrocarbon reservoir. The squeeze treatment asphaltene scale inhibitors may be considered effective in preventing or reducing asphaltene scale deposition when the asphaltene scale inhibitor concentration in the hydrocarbon reservoir is greater than a minimum inhibitor concentration (MIC) necessary to keep asphaltenes in solution. The MIC may vary based on the longer lasting asphaltene scale deposition squeeze treatment inhibitor and the hydrocarbon reservoir conditions.

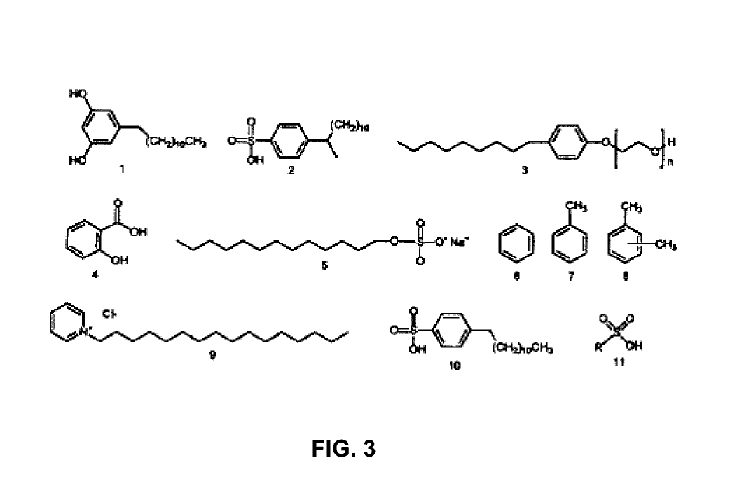

The squeeze treatment asphaltene scale inhibitor may include an asphaltene inhibitor modified with a functional group that controls adsorption-desorption kinetics of the squeeze treatment asphaltene scale inhibitor in the rocks of a hydrocarbon reservoir. The asphaltene inhibitor may be any suitable asphaltene inhibitor, such as a chemical stabilizer that controls asphaltene precipitation. According to one embodiment, the asphaltene inhibitor may be at least one of a resorcinol, sulfonic acid, phenol, phenolic acid, organosulfate, sulfonate and aromatic hydrocarbon. For example, the asphaltene inhibitor to be modified with a a functional group that controls adsorption-desorption kinetics may be at least one of (1) dodecyl resorcinol (DR), (2) linear alkyl benzene sulfonic acid (LABS), (3) ethoxylated nonyl phenol, (4) salicylic acid, (5) sodium dodecyl sulfate, (6) benzene, (7) toluene, (8) xylenes, (9) cetylpyridnium chloride, (10) dodecyl benzene sulfonic acid (DBSA) and (11) petroleum sulfonate, as shown in FIG. 3.

The functional group that controls adsorption-desorption kinetics may be any suitable functional group, such as a functional group that controls the adsorption-desorption kinetics of pre-existing squeeze treatment inorganic scale inhibitors. The functional group that controls adsorption-desorption kinetics may be a functional group that slows the desorption rate of the squeeze treatment asphaltene scale inhibitor from the rocks that form a hydrocarbon reservoir, such that the squeeze treatment asphaltene scale inhibitor is released from the rocks over a longer period of time. The functional group that controls adsorption-desorption kinetics may be a functional group that increases the adsorption rate at which the squeeze treatment asphaltene scale inhibitor is adsorbed to the rocks that form a hydrocarbon reservoir, such that a larger amount of the squeeze treatment asphaltene scale inhibitor is adsorbed to the rocks. According to one embodiment, the functional group that controls adsorption-desorption kinetics may be a functional group that slows the desorption rate of the squeeze treatment asphaltene scale inhibitor from the rocks that form a hydrocarbon reservoir and increases the adsorption rate at which the squeeze treatment asphaltene scale inhibitor is adsorbed to the rocks that form a hydrocarbon reservoir.

According to another embodiment, the squeeze treatment asphaltene scale inhibitor may include a pre-existing asphaltene scale deposition inhibitor modified by a functional group that may also be utilized to control the adsorption-desorption kinetics of a squeeze treatment inorganic scale inhibitor. The functional group that controls adsorption-desorption kinetics may produce the desired effect at ambient temperature and pressure, high temperature and pressure, or both. The squeeze treatment asphaltene scale inhibitor may include a plurality of functional group that controls adsorption-desorption kinetics.

The longer lasting asphaltene scale deposition squeeze treatment inhibitors may not block the pores of, degrade or damage the rocks forming the hydrocarbon reservoir. The longer lasting asphaltene scale deposition squeeze treatment inhibitors may preserve the integrity of the hydrocarbon reservoir after addition to the hydrocarbon reservoir.

The longer lasting asphaltene scale deposition inhibitors may be added to a well and/or hydrocarbon reservoir by any suitable process. According to one embodiment the addition process may be a squeeze treatment process. The squeeze treatment process may include an addition period and a well shut-in period. The squeeze treatment process may take place over a period of less than about 4 days, such as a period in the range of about 2 to about 3 days.

As used herein, the singular forms “a”, “an” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An asphaltene precipitation and/or flocculation inhibitor with a molecular weight of less than about 1000, wherein the asphaltene precipitation inhibitor comprises an aromatic core and the inhibitor exhibits charge transfer.

2. The inhibitor of claim 1, wherein the molecular weight is at least about 78.

3. The inhibitor of claim 1 wherein the inhibitor has π-π interaction with asphaltene.

4. A method of reducing asphaltene precipitation comprising:
adding an asphaltene precipitation inhibitor to a hydrocarbon reservoir, well or oil production pipeline;
non-covalently interacting the inhibitor with asphaltene through π-π interaction;
forming a nanoaggregate of inhibitor and asphaltene in solution.

5. The method of claim 4, wherein adding the asphaltene precipitation inhibitor comprises a squeeze treatment process or a downhole continuous injection process.

6. The method of claim 4, wherein the inhibitor has a molecular weight of less than about 1000.

7. The method of claim 4, wherein the nanoaggregate comprises asphaltene micelles and the inhibitor is disposed within the asphaltene micelle.

8. A method of reducing asphaltene scale deposition comprising:
adding an asphaltene scale deposition squeeze treatment inhibitor to a hydrocarbon reservoir.

9. The method of claim 8, wherein adding the asphaltene scale deposition squeeze treatment inhibitor to the hydrocarbon reservoir comprises a squeeze treatment process.

10. The method of claim 8, wherein the inhibitor comprises a compound selected from the group of (1) dodecyl resorcinol (DR), (2) linear akyl benzene sulfonic acid (LABS), (3) ethoxylated nonyl phenol, (4) salicylic acid, (5) sodium dodecyl sulfate, (6) benzene, (7) toluene, (8) xylenes, (9) cetylpyridinium chloride, (10) dodecyl benzene sulfonic acid (DBSA), and (11) petroleum sulfonate; wherein the inhibitor is modified by a functional group that alters adsorption/desorption kinetics of the inhibitor.

11. The method of claim 10, further comprising modifying the inhibitor with a functional group that alters adsorption/desorption kinetics of the inhibitor.
